(19) United States
(12) Patent Application Publication
(10) Pub. No.: US 2022/0234085 A1
(43) Pub. Date: Jul. 28, 2022

(54) OIL TANK CLEANING BALL

(71) Applicant: CHIAN -YEU CHIEN, Yunlin (TW)

(72) Inventor: CHIAN -YEU CHIEN, Yunlin (TW)

(21) Appl. No.: 17/155,111

(22) Filed: Jan. 22, 2021

(51) Int. Cl. B08B 9/087

(52) U.S. Cl. CPC B08B 9/087

(57) ABSTRACT

An oil tank cleaning ball serves for attracting metal impurities within an oil tank, and has a function of checking whether the oil tank is dirty. The oil tank cleaning ball comprises an enclosing body made of non-magnetic material, but the magnetic lines can pass through the enclosing body, an outer surface of the enclosing body being uneven and rough, having sags and crests so as to expand an area of the outer surface for attracting impurities; a magnetic metal sheet enclosed within and fixed by the enclosing body; the magnetic lines emitting from the magnetic metal sheet can pass through the enclosing body so as to attract the impurities within the oil tank. Amount of impurities on the oil tank cleaning ball is used to decide whether an interior of the oil tank is dirty.

### FIELD OF THE INVENTION

The present invention is related to cleaning of oil tanks, and in particular to an oil tank cleaning ball.

### BACKGROUND OF THE INVENTION

In manufacturing, transportation and storage of gasoline, gasoline must contact with different kinds of manufacturing tools, devices and storage tanks, generally, these tools, devices or tanks contain large amount of metals which will generate with many metal impurities such as iron powders, rust powders, or impurities of metal particles or powders. These impurities will mix into the gasoline and then flow into the oil tanks of vehicles and sink in the bottom of the oil tank. For a long time, these impurities will seal the oil pump to cause that the pump cannot act and thus gasoline will not flow out of the oil tank to provide to the engine.

Above mentioned conditions will cause the vehicles cannot move so as to induce traffic jams abruptly and thus cause the traffic chaos, as a result, the driver needs to hire a tow truck to move the destroyed vehicle away. All these actions are time and money wasted.

In general maintenance works, the worker does not check whether the interior of the oil tank is dirty and how much metal powders stayed therein. This is because these works must be performed with the work of opening the oil tank, while to open the oil tank is a very difficult work.

Therefore, the object of the present invention is to provide a novel structure which can reduce the metal impurities such as iron powders, rust powders, or impurities of metal particles or powders. Furthermore the user can also check whether the oil tank is needed to be cleaned so as to avoid the destroy of the oil tank due to the seal of the oil pump.

### SUMMARY OF THE INVENTION

Accordingly, the object of the present invention is to provide an oil tank cleaning ball, wherein the impurities (for example, iron powders, rust powders, or other impurities such as metal particles or powders) within an oil tank can be cleaned easily and conveniently by the oil tank cleaning ball of the present invention. Another, the oil tank cleaning balls can be used to check whether the interior of the oil tank is sufficient dirty so that it is needed to be cleans. These functions provide sufficient convenience to the drivers. It can be used to prevent that the oil pump does not act abruptly due to the pump is sealed by metal impurities. Therefore, it can avoid many traffic jam accidents due to the destroy of the oil pump.

To achieve above object, the present invention provides an oil tank cleaning ball for attracting metal impurities within an oil tank, the impurities including iron powders, rust powders, or other metal particles or powders; and the oil tank cleaning ball having a function of checking whether the oil tank is dirty; the oil tank cleaning ball comprising; an enclosing body made of non-magnetic material, but the magnetic lines can pass through the enclosing body, an outer surface of the enclosing body being uneven and rough, having sags and crests so as to expand an area of the outer surface for attracting impurities; a magnetic metal sheet enclosed within and fixed by the enclosing body; the magnetic lines emitting from the magnetic metal sheet can pass through the enclosing body so as to attract the impurities within the oil tank; and wherein the oil tank cleaning ball is placed into an oil tank and is sunk to a lower side of the oil tank so that the oil tank cleaning ball can attract the impurities on the bottom of the oil tank to avoid these impurities to seal an oil pump in the bottom of the oil tank; and amount of impurities on the oil tank cleaning ball is used to decide whether an interior of the oil tank is dirty so that it is necessary to be cleaned.

### BRIEF DESCRIPTION OF THE DRAWINGS

FIG. 1 is a schematic view showing the elements of the present invention.

FIG. 2 is an exploded schematic view about the two sheet bodies of the enclosing body according to the present invention.

FIG. 3 is a schematic view showing the combination of the elements in FIG. 2.

FIG. 4 is an exploded schematic view of another sheet body of the present invention.

FIG. 5 is a schematic view showing the assembly of the elements of FIG. 4.

FIG. 6 is a schematic view showing the application of the present invention.

FIG. 7 is schematic view showing another application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

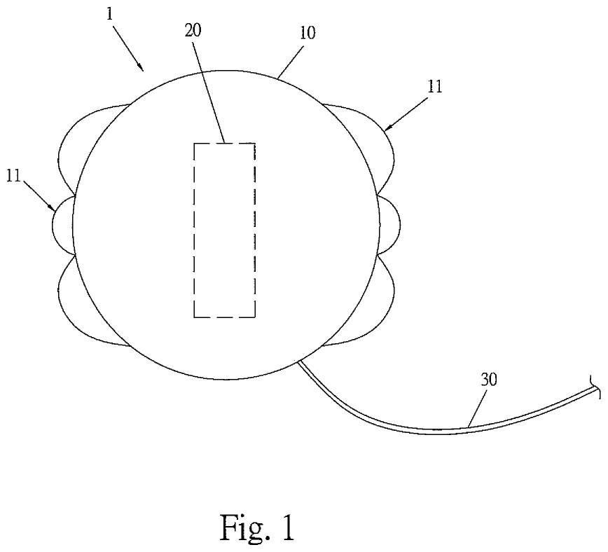

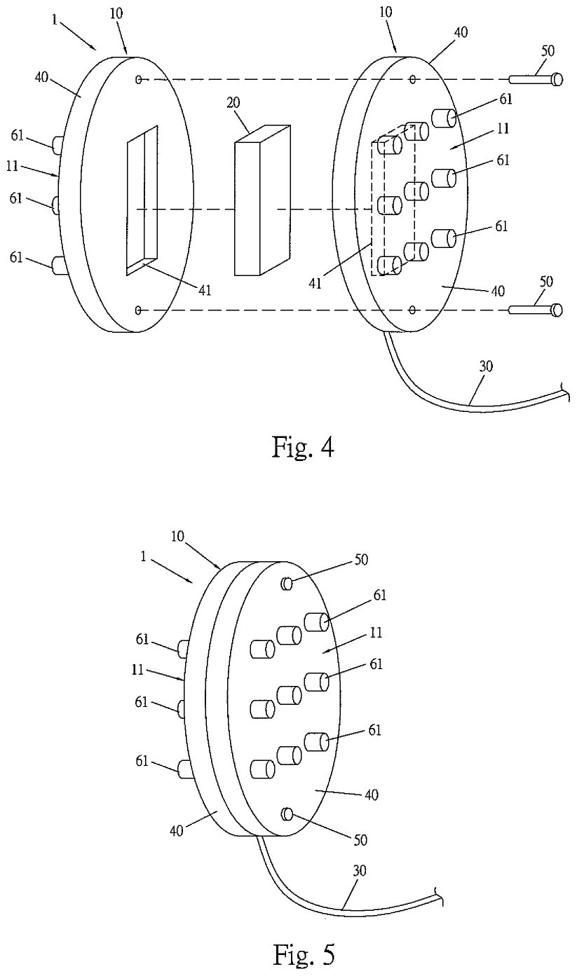

With reference to FIGS. 1 to 7, the oil tank cleaning ball 1 according to the present invention is illustrated. The present invention includes the following elements.

An enclosing body 10 is made of non-magnetic material, but magnetic lines can pass through the enclosing body 10, such as rubber, plastics, etc. Referring to FIG. 1, an outer surface 11 of the enclosing body 10 are uneven and rough, has sags and crests so as to expand an area of the outer surface 11 for attracting impurities, such as iron powders, rust powders, or other metal particles or powders.

A magnetic metal sheet 20 is enclosed within and fixed by the enclosing body 10. Preferably, the magnetic force from the magnetic metal sheet 20 are proper so that it only acts in a near field of the enclosing body 10 so as to attract the impurities nearby, while the enclosing body 10 is not attached to walls of oil tanks.

A line 30 has one end attached to the enclosing body 10.

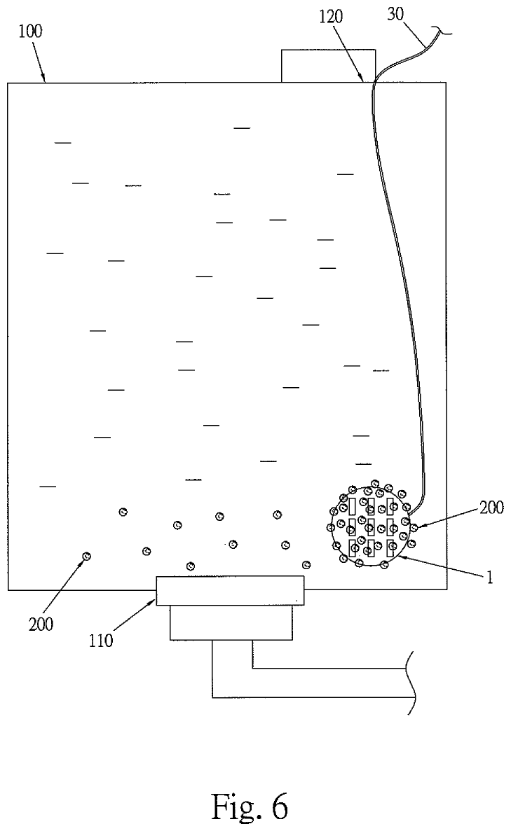

Referring to FIG. 6, in use of the present invention, the oil tank cleaning ball 1 of the present invention is placed into to an oil tank 100, sinks in the gasoline of the oil tank 100 and places to a bottom of the oil tank 100 so that the oil tank cleaning ball 1 can attract the impurities on the bottom of the oil tank 100 to avoid these impurities to move to an oil pump 110 in the bottom of the oil tank 100 so as to seal the oil pump 110 and cause the oil pump 110 cannot act. The line 30 connected to the enclosing body 10 is exposed out of an opening 120 of the oil tank 100 so that the user can pull the oil tank cleaning ball 1 from the line 30 to cause the oil tank cleaning ball 1 moves out from the oil tank 100. Thereby, the use can clean the oil tank cleaning ball 1 and can view the oil tank cleaning ball 1 to decide whether an interior of the oil tank 100 is dirty and to decide whether the oil tank 100 is necessary to be cleaned.

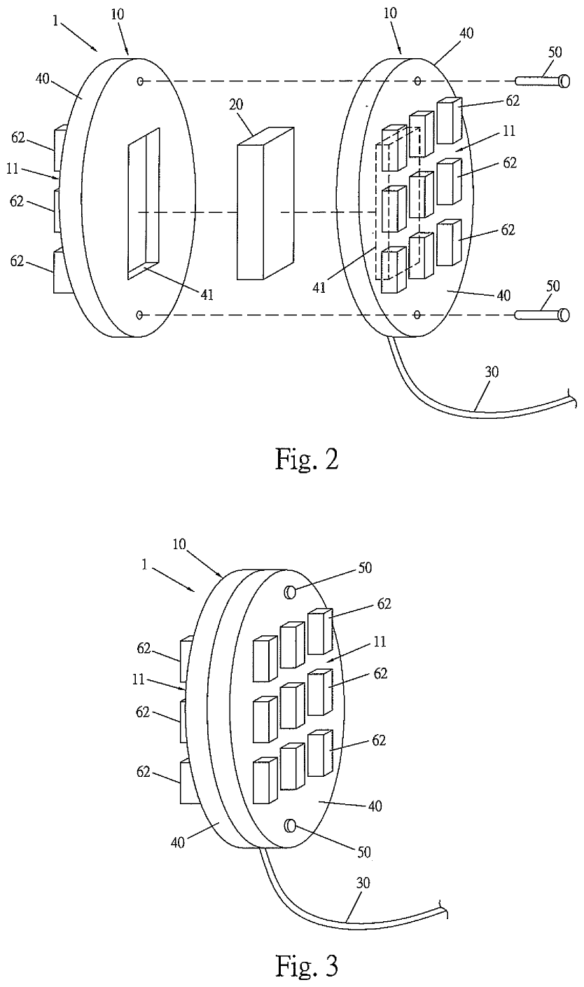

With reference to FIGS. 2 to 5, in this embodiment, the enclosing body 10 is formed by two sheet bodies 40. An inner side of each sheet body 40 is formed with a recess 41. After combining the two sheet bodies 40, the magnetic metal sheet 20 is enclosed with the two recesses 41 of the two sheet bodies 40. One inner surface of one sheet body 40 is corresponding to that of another sheet body 40 so that after combination, the magnetic metal sheet 20 is tightly sealed within the recesses 41.

Combination of the sheet bodies 40 is performed by any way which can combining the two sheet bodies 40, such as screwing by screws or studs, sticky, or buckling, etc. Referring to FIGS. 3 and 5, it is illustrated that two screws 50 pass through the two sheet bodies 40 so as to combine the two sheet bodies 40 as one integral body and the magnetic metal sheet 20 are enclosed within the recesses 41.

After combination, the magnetic metal sheet 20 are enclosed within the recesses 41, the magnetic lines emitting from the magnetic metal sheet 20 can pass through the enclosing body 10 so as to attract the impurities with the lower side of the oil tank 100.

In the present invention, the outer surface 11 of each sheet body 40 is uneven for providing greater surface area for locating impurities. In the present invention, unevenness of each outer surface 11 of the sheet body 40 is formed by a plurality of round posts 61 (referring to FIGS. 2 and 3), or a plurality of rectangular posts 62 (referring to FIGS. 2 and 5) so as to provide larger combining area.

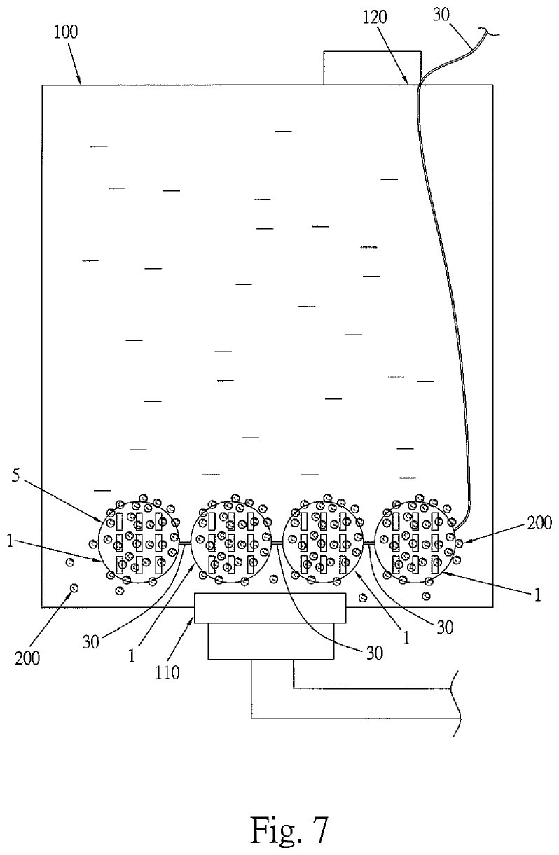

FIG. 7 shows another embodiment of the present invention, in this embodiment, a plurality of oil tank cleaning balls 11 are connected so as to form as an oil tank cleaning ball set 5. In use, this oil tank cleaning ball set 5 can provide a larger area for attracting impurities. In FIG. 7, there are four oil tank cleaning balls 1 are connected together.

In above mentioned applications, the oil tank cleaning balls 1 can be connected by any ways which are all within the scope of the present invention, for example, by using the line 30 to connect the oil tank cleaning balls 1 one by one.

Advantages of the present invention are that the impurities (for example, iron powders, rust powders, or other impurities such as metal particles or powders) within an oil tank can be cleaned easily and conveniently by the oil tank cleaning ball of the present invention. Another, the oil tank cleaning balls can be used to check whether the interior of the oil tank is sufficient dirty so that it is needed to be cleans. These functions provide sufficient convenience to the drivers. It can be used to prevent that the oil pump does not act abruptly due to the pump is sealed by metal impurities. Therefore, it can avoid many traffic jam accidents due to the destroy of the oil pump.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An oil tank cleaning ball for attracting metal impurities within an oil tank, the impurities including iron powders, rust powders, or other metal particles or powders; and the oil tank cleaning ball having a function of checking whether the oil tank is dirty; the oil tank cleaning ball comprising:
an enclosing body made of non-magnetic material, but the magnetic lines can pass through the enclosing body, an outer surface of the enclosing body being uneven and rough, having sags and crests so as to expand an area of the outer surface for attracting impurities;
a magnetic metal sheet enclosed within and fixed by the enclosing body; the magnetic lines emitting from the magnetic metal sheet can pass through the enclosing body so as to attract the impurities within the oil tank; and
wherein the oil tank cleaning ball is placed into an oil tank and is sunk to a lower side of the oil tank so that the oil tank cleaning ball can attract the impurities on the bottom of the oil tank to avoid these impurities to seal an oil pump in a bottom of the oil tank; and amount of impurities on the oil tank cleaning ball is used to decide whether an interior of the oil tank is dirty so that it is necessary to be cleaned.

2. The oil tank cleaning ball as claimed in claim 1, the further comprising a line having one end attached to the enclosing body.

3. The oil tank cleaning ball as claimed in claim 1, wherein material of the enclosing body is selected from rubber and plastics.

4. The oil tank cleaning ball as claimed in claim 1, wherein the magnetic force from the magnetic metal sheet only acts in a near field of the enclosing body so as to attract the impurities nearby, while the enclosing body is not attached to walls of the oil tanks.

5. The oil tank cleaning ball as claimed in claim 1, wherein the enclosing body is formed by two sheet bodies; an inner side of each sheet body is formed with a recess; after combining the two sheet bodies, the magnetic metal sheet is enclosed with the two recesses of the two sheet bodies.

6. The oil tank cleaning ball as claimed in claim 5, wherein one inner surface of one sheet body is corresponding to that of another sheet body so that after combination of the two sheet bodies, the magnetic metal sheet is tightly sealed within the recesses.

7. The oil tank cleaning ball as claimed in claim 5, wherein combination of the sheet bodies is performed by screwing by screws or studs, sticky, or buckling.

8. The oil tank cleaning ball as claimed in claim 5, wherein at least one screw passes through the two sheet bodies to combine the two sheet bodies.

9. The oil tank cleaning ball as claimed in claim 5, wherein the unevenness on the outer surface of each sheet body is formed by a plurality of round posts extended from an outer surface of the sheet body so as to provide larger area.

10. The oil tank cleaning ball as claimed in claim 5, wherein the unevenness on the outer surface of each sheet body is formed by a plurality of rectangular posts extended from an outer surface of the sheet body so as to provide larger area.

11. The oil tank cleaning ball as claimed in claim 1, wherein the oil tank cleaning ball can be connected with another oil tank cleaning ball so as to provide large range for attracting impurities.
